(19) United States
(12) Patent Application Publication
(10) Pub. No.: US 2014/0358626 A1
(43) Pub. Date: Dec. 4, 2014

(54) ASSESSING THE IMPACT OF AN INCIDENT IN A SERVICE LEVEL AGREEMENT

(71) Applicant: Hewlett-Packard Development Company, L.P., Houston, TX (US)

(72) Inventors: Soumendu Bardhan, Tulsa, OK (US); Rajeev Jain, Austin, TX (US); Dejan S. Milojicic, Palo Alto, CA (US)

(21) Appl. No.: 13/909,901

(22) Filed: Jun. 4, 2013

(51) Int. Cl. G06Q 10/06

(52) U.S. Cl. CPC G06Q 10/0635
USPC 705/7.28

(57) ABSTRACT

Assessing the impact of an incident in a Service Level Agreement (SLA) by a system including a plurality of nodes organized in a hierarchical structure is disclosed. An incident record for an incident related to a service at a first node is received and an actual impact of the incident at the first node is calculated. The calculated actual impact is transferred to a parent node until a root node is reached. The actual impact of the incident is calculated at the parent node and a final actual impact and a total financial impact for the SLA are calculated at the root node. The actual impact at each node, the final actual impact, and the total financial impact are calculated dynamically while the incident is in progress.

### BACKGROUND

Due to major developments in the area of information technology (“IT”) over the past years, many businesses heavily use some type of IT infrastructure in their daily operations (e.g., email servers, database servers, web servers, etc.). In many situations, depending on the size of the business, it is not possible for a particular business to manage its own IT infrastructures on site. Therefore, these businesses often outsource their IT infrastructure needs. For that reason, datacenters that offer various IT infrastructure services and resources have become very popular in recent years. Generally, the operations of the datacenters and the services offered to a business are regulated by a Service Level Agreement (“SLA”). An SLA is a service contract between two parties (e.g., provider of services and a business using the services) where a service is formally defined.

### BRIEF DESCRIPTION OF THE DRAWINGS

FIG. 1 is a schematic illustration of an example of a system for assessing an actual impact and a financial impact for an existing SLA for a datacenter based on an incident in the datacenter.

FIG. 2 illustrates a schematic representation showing an example of a computing device of the system of FIG. 1.

FIG. 3 is a schematic illustration showing an example of a machine-readable storage medium encoded with instructions executable by the processor of the computing device of FIG. 2.

FIG. 4 illustrates an example of an incident record for an incident related to a service at a service node and an SLA parameters record.

FIG. 5 illustrates a flow chart showing an example of a method for assessing an actual impact and a financial impact for an existing SLA for a datacenter based on an incident in the datacenter.

FIG. 6 illustrates an example of a time metric object used for calculation of an actual impact at each node.

FIG. 7 shows a table illustrating an example of calculating a probabilistic estimate of a penalty at a node based on an incident.

FIGS. 8 and 9 are flow charts illustrating an example of a method for determining a criticality of an incident at a node included in a hierarchical datacenter structure and for comparing the criticality of at least two incidents.

### DETAILED DESCRIPTION

In a typical datacenter environment, services to different business may include thousands of hardware and software components, where multiple incidents can occur daily. The services offered by the service provider to the customer are defined in at least one SLA. In many cases (i.e., where the provider offers more than one service in the datacenter), the services between the parties are defined by a plurality of SLAs. It is common that various incidents interrupt the daily operation of a datacenter. Some of the incidents that occur in a datacenter may cause service disruptions that are in violation of the existing SLAs between the provider of services and the customer (i.e., the business). For example, most SLAs include a Quality of Service section that specifically describes the quality of service level or required uptime during a specific time metric unit (e.g., 99% of service availability per month, etc.) that must be supplied by the service provider. When an incident or a service disruption causes the Quality of Service to fall below the expected level, the SLA contract may be breached and that can result in substantial financial penalties to the service provider.

In most cases, when an incident at the datacenter occurs and is in process, the criticality of the incident (e.g., its financial implication) is not known to the datacenter managers until the end of the contractual time period (e.g., month) defined in the Quality of Service portion of the SLA when the accounting activities for that time period are carried out. In addition, there is no effective way to determine, at run-time (i.e., while the incident is still in progress), whether the incident has any impact on existing SLAs because the SLA rules associated with the incident are either unknown or too complicated to compute within a short period of time. Since every downtime time metric unit (e.g., minute) could result in significant financial loss, understanding the financial implications of each downtime minute, while the incident is in progress, may allow the datacenter incident management team to minimize the overall SLA financial penalties.

In some situations, a typical enterprise environment can include a large number of business services or systems per customer, where each system supports a large number of service nodes representing services for that customer (e.g., email services, web services, mobile services, database services, etc.). Each service, in turn, is supported by a diverse collection of physical entities or sub-systems (e.g., web-servers, virtual machines, databases, application servers, storage, networking systems etc.). In some situations, SLAs are not only defined for the root node (i.e., the Entire Service) and for each service node, but also for each of their sub-systems and components. Therefore, in a large-scale datacenter having a complicated hierarchical structure, it becomes difficult to distinguish incidents which may impact an SLA from those which may not. This is primarily due to the absence of clear mapping of services to their physical resources (i.e., to the physical entities) at each node level but also due to the fact that the SLA rules vary from node to node within the same service.

In addition, incidents that impact the SLA in a datacenter versus incidents that do not impact the SLA cannot be identified during the occurrence of the incident for a number of other reasons. For example, some incidents may be caused by customers or third parties and, therefore, may not impact the SLA under the terms of the contract. Also, other incidents may fall outside the time-range (e.g. weekdays from 6:00 a.m.-12:00 a.m.) when services must be provided that is defined in the SLA. There could also be “planned” outages in the services that do not impact the SLA because these are pre-arranged between the client and the provider (e.g., may be used for maintenance activities). Further, some incidents may have lower “severity” (as defined by the SLA) and may not impact the services and the SLA.

Due to the inability to differentiate incidents that may impact the SLA and may lead to financial penalties from inconsequential incidents, datacenter managers cannot target and reroute resources to those incidents which have higher financial impact. This problem is amplified when multiple incidents at the datacenter occur at the same time, and there is no basis for prioritizing the incidents according to their financial implications to the service provider. Examples described herein allow datacenter personnel to correlate each minute of an ongoing incident to the financial impact the incident has on the provider based on the exiting SLA for the datacenter. That way, datacenter managers can deploy the resources of the datacenter more effectively in order to reduce the overall financial loss.

This description is directed to systems, methods, and machine-readable storage media to assess, at run-time (i.e. while an incident is in progress), whether an incident in a datacenter has an actual impact and a financial impact on any existing SLA for the datacenter. Further the proposed systems, methods, and machine-readable storage media compute the criticality of the incident, while the incident is in progress, by providing the time (e.g., number of minutes) remaining before an SLA violation occurs and the financial penalty if the SLA is breached. Based on these timely metrics, datacenter managers can target remedial activities more effectively such that the overall financial loss to the service provider is minimized. In one example, the actual impact is the outage time (i.e., unplanned outage time or downtime) calculated based on information about the incident, the local SLA rules at each node, and physical entities supporting each node. The final actual impact is the total outage time for the incident at the root node, which represents the unplanned outage time or downtime. The total financial impact represents a probabilistic estimate of a penalty based on the total outage time at the root node.

In particular, the description is directed to systems, methods, and machine-readable storage media for a plurality of nodes in a datacenter organized in a hierarchical structure and related to a main SLA. The description proposes receiving an incident record for an incident related to a service at a first node, calculating an actual impact of the incident at the first node, and transferring the calculated actual impact to a parent node until a root node is reached. Further, the description proposes calculating the actual impact of the incident at the parent node, and calculating a final actual impact and a total financial impact for the main SLA at the root node. The actual impact at each node, the final actual impact, and the total financial impact are calculated dynamically while the incident is in progress, which includes calculating values for the actual impact, the final actual impact, and the total financial impact for each time metric unit of the incident while the accident is progressing.

In the situation where several incidents occur at the same time, the description further proposes calculating a time-to-violation of the main SLA at the root node for each incident, determining a criticality of each incident based on the time-to-violation and the total financial impact, and comparing the criticality of at least two incidents that occur at the same time. In one example, calculating the actual impact of the incident at each node includes evaluating an incident record and local SLA rules at each node at a node level and determining an outage time based on the incident record, the local SLA rules at each node, and physical entities supporting each node. Calculating the total financial impact includes calculating a probabilistic estimate of a penalty based on a total outage time at the root node.

The proposed systems, methods, and machine-readable storage media allow datacenter personnel to determine, while the incident is in progress, whether an incident has an impact on an existing SLA, and to compute the criticality of the incident by calculating the time remaining before an SLA violation occurs and the potential financial penalty if the SLA is breached. Thus, improved loss reduction at the datacenter is achieved because datacenter managers can make cost-effective decisions related to specific services and their supporting sub-systems (e.g. to repair, replace, build, etc.) based on the deeper visibility of the financial impact of each incident while the incident is in progress.

As used herein, the term SLA refers to a contractual agreement between two parties (e.g., a provider of services and a customer) that formally defines various services delivered by one party (e.g., the provider of services) to another (e.g., the customer). In some examples, the provided services are managed by a datacenter that includes a plurality of nodes organized in a hierarchical or tree structure having a root node that relates to a main SLA.

As used herein, the terms root node or an Entire Service may be used interchangeably and refer to a high-level business service (e.g., hotel reservation service, stock trading service, online banking service, procurement service, shipping service, etc.), which represents a group of business activities supported by underlying IT services described in a main SLA related to the business service. In addition, the term service node refers to a node in the main SLA hierarchical structure that is below the root node and represents a specific service (e.g. hotel reservation system, car reservation system, email system, etc.), which in turn may be covered by another lower level SLA.

As used herein, the terms physical entity or sub-system may be used interchangeably and refer to a tangible resource or a group of tangible resources (e.g., servers, virtual machines, databases, application servers, storage, networking systems etc.) to support the services in the SLA hierarchical structure.

As used herein, the term incident refers to any event which is not part of the standard operation of a service under an SLA and which causes, or may cause, an interruption to or a reduction in the quality of that service. Further the term outage refers to an actual disruption of service caused by an incident or any other event which may or may not impact the SLA. In some examples, the outage may be planned or scheduled (i.e., included in the SLA) or unplanned (i.e., not included in the SLA and due to an incident).

Further, as used herein in relation to an incident in a database covered by an SLA, the terms outage time, downtime, or outage period may be used interchangeably and refer to the total amount of time (e.g., in minutes) that a service (e.g., Entire Service or a service node) or a physical entity is not in operation and is not providing the specific service described in the SLA. In some examples, the outage time for services described in an SLA is evaluated during a specific time metric unit (one day, one month, two months, etc.). The outage time or downtime can include planned or scheduled downtime, which is specifically described in the SLA. For example, the planned downtime outlined in the SLA includes time windows that are reserved for maintenance activities or a time frame during which the service is not required by the customer. Therefore, incidents during the planed downtime do not impact the SLA. Further, outage time or downtime can include unplanned downtime or outage time, for which the provider may be liable financially if the unplanned downtime exceeds a specific amount of time described in the SLA.

As used herein, the terms uptime, uptime period, or uptime minutes may be used interchangeably and refer to the total amount of time (e.g., minutes) in a time metric unit (e.g., day, month, year, etc.) during which a service (e.g., Entire Service or a service node) or a physical entity is in operative state as defined in the SLA. In some examples, the uptime period can include the sum of the active service time (i.e., the service availability time—when the provider is supplying service to the customer) and the standby time (when the provider is not supplying service as described in the SLA—e.g., during the night time). Further, the uptime period can include the total time in a time metric unit (e.g., day, month, year, etc.) minus the planned downtime for the specific metric unit.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

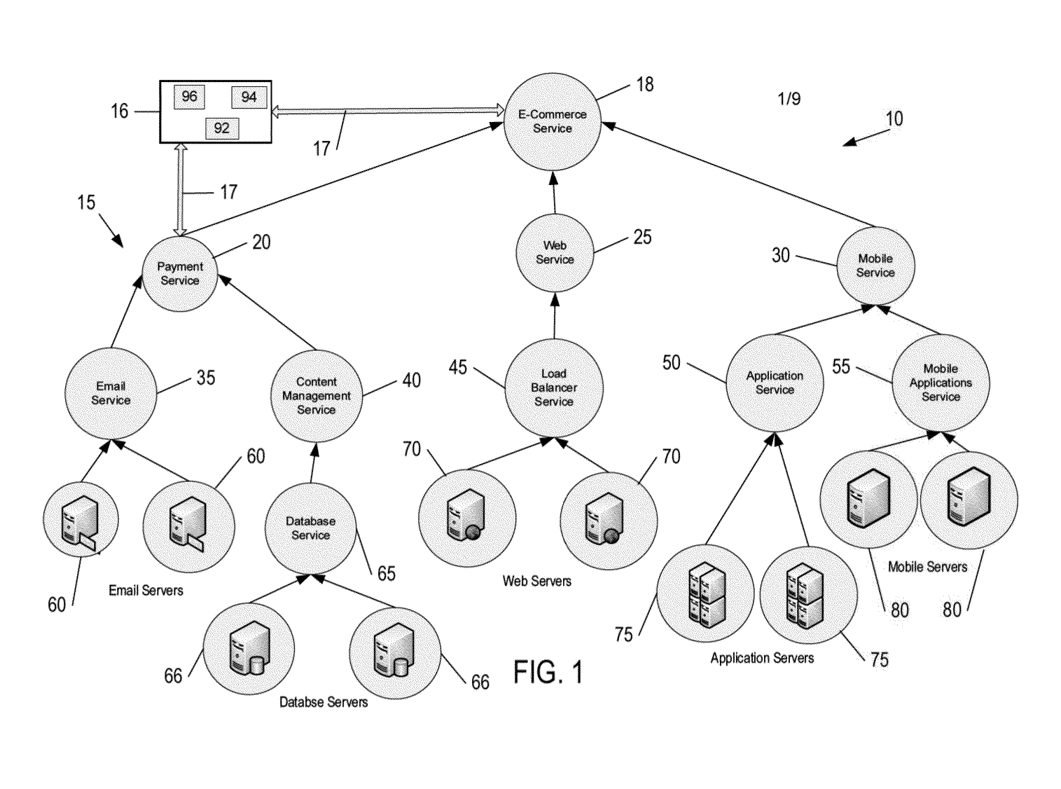

FIG. 1 is a schematic illustration of an example of a system 10 for assessing an actual impact and a financial impact for an existing SLA for a datacenter based on an incident in the datacenter. The system 10 includes at least one datacenter structure 15, a computing device 16, and a network 17. The computing device 16 is in communication with the datacenter 15 via the network 17. In one example, the computing device 16 includes a processor 92, a memory 94, and an incident analysis module 96 to calculate an actual impact of an incident at a first node, the actual impact of the incident at a parent node, and a final actual impact and a total financial impact for the main SLA at the root node.

The datacenter 15 illustrates an example of a datacenter providing various IT services to customers under a main SLA (not shown). The datacenter includes a plurality of nodes organized in a hierarchical structure that is related to the main SLA. The nodes include a root node or E-Commerce Service node 18 (also called an Entire Service) that represents a high level business service supported by the datacenter under the main SLA. The nodes in the datacenter or hierarchical structure 15 further include a plurality of service nodes that are below the root node 18 and represent specific services associated with the main E-Commerce Service node 18. In the illustrated example, the service nodes include Payment Service node 20, Web Service node 25, Mobile Service node 30, Email Service node 35, Content Management Service node 40, Load Balancing Service node 45, Application Service node 50, Mobile Application Service node 55, and Database Service node 65.

In addition, the nodes in the datacenter 15 include a plurality of physical entities or sub-systems that support the services in the SLA hierarchical structure. In the illustrated example, the physical entities include email servers 60 supporting the Email Service node 35, database servers 66 supporting the Database Service node 65, web servers 70 supporting the Web Service node 25 and the Load Balancer Service node 45, application servers 75 supporting the Application Service node 50, and mobile servers 80 supporting the Mobile Application Service node 55.

In some examples, SLA rules defined at each service (i.e., service node level) govem the service provided by the service provider to the customer. These SLA rules are explicitly negotiated beforehand between the customer and the provider and may be stored at each node of the datacenter 15. Therefore, in one example, the rules defining the main SLA for the datacenter 15 are stored at the root node 18. Further, independent local SLA rules may be defined for any of the service nodes below the root node 18 in the datacenter 15. In addition, as explained in additional detail below, local SLA rules may be defined for the nodes that represent the physical entities that support the service nodes.

For example, the defined SLA rules at each service node level can include the required service availability for a specific time metric unit (e.g., 99% service availability for the E-Commerce Service 18 per month, 98% service availability for the Mobile Service 30 per month, etc.), the planned downtime and the unplanned downtime for the specific time metric unit (e.g., 3000 minutes of planned downtime per month, 60 minutes of unplanned downtime per month, etc.), the required uptime period for the service (which may relate to the required service availability), the standby time, etc. In the situations where SLA rules are defined for the physical entities nodes, these rules may include the number of physical entities (e.g., servers) required to support a service (e.g., two servers 60 are required to support the Email Service 35, etc.), the number of physical entities that need to be running at all times (e.g., one of the servers 60 is required to be available 99% of the time to support the Email Service 35), etc.

As described in additional detail below, in some situations, the service provider may have a number of physical entities supporting a service that is greater than the actual number required by the SLA (e.g., six servers may be available when only three are required under the SLA). In addition, the SLA rules at each service node (i.e., the root node and the rest of the lower service node) define specific financial penalties for violation of the SLA requirements for the specific time period (e.g., month) of the SLA (e.g., a penalty of $100,000 applies if the unplanned downtime per month is greater than 60 minutes, etc.).

The network 17 connects the computing device 16 and the root node 18 so the root node 18 can transmit information to the computing device 16 and the computing device 16 can transmit information to the root node 18. Alternatively, the computing device 16 can be connected to any other service nodes or physical entities of the datacenter 15. The network 17 may include any suitable type or configuration of network to allow the computing device 16 to communicate with the nodes or physical entities supporting the nodes.

For example, the network 17 may include a wide area network (“WAN”) (e.g., a TCP/IP based network, a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a Digital Enhanced Cordless Telecommunications (“DECT”) network, a Digital AMPS (“IS-136/TDMA”) network, or an Integrated Digital Enhanced Network (“iDEN”) network, etc.). The network 17 can further include a local area network (“LAN”), a neighborhood area network (“NAN”), a home area network (“HAN”), a personal area network (“PAN”), a public switched telephone network (“PSTN”), an Intranet, the Internet, or any other suitable network.

The computing device 16 provides functionality to calculate an actual impact and a financial impact on an existing SLA for the datacenter 15 based on an incident in the datacenter while the incident is still in progress. It is to be understood that the operations performed by the computing device 16 that are related to this description can be performed by any other computing device associated with or supporting the root node 19 and/or the plurality of service nodes in the datacenter 15. As described in additional detail below, in one example, the computing device 16 receives an incident record for an incident related to a service at a first node, calculates an actual impact of the incident at the first node, transfers the calculated actual impact to a parent node until a root node is reached, calculates the actual impact of the incident at the parent node, and calculates a final actual impact and a total financial impact for the main SLA at the root node 18.

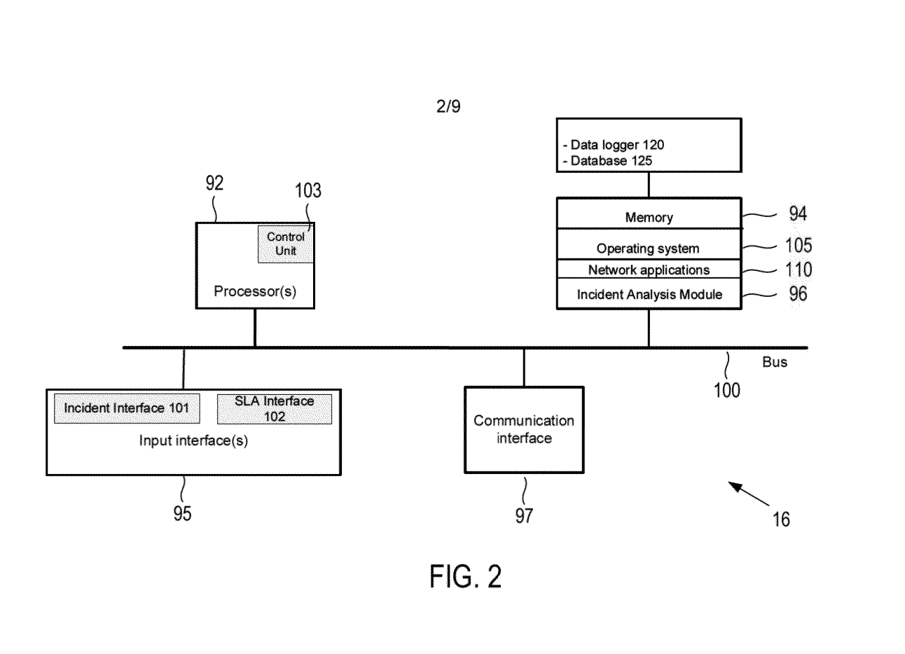

FIG. 2 shows a schematic representation of the computing device 16 of the system 10. The computing device 16 can be a server, a desktop computer, a laptop, or any other suitable device capable of carrying out the methods described below. The computing device 16 can be an independent device or can be one of the devices supporting the service nodes in the datacenter 15. The computing device 16 includes a processor 92 (e.g., a central processing unit, a microprocessor, a microcontroller, or another suitable programmable device), a memory 94, input interfaces 95, and a communication interface 97. Each of these components is operatively coupled to a bus 100. For example, the bus 100 can be an EISA, a PCI, a USB, a FireWire, a NuBus, or a PDS. In other examples, the computing device 16 includes additional, fewer, or different components for carrying out similar functionality described herein.

The communication interface 97 enables the computing device 16 and the system 10 to communicate with a plurality of networks. The input interfaces 95 can process information from the root node 18, the service nodes, the physical devices of the datacenter 15, or another external device/system. In one example, the input interfaces 95 include at least an incident interface 101 and an SLA interface 102. In other examples, the input interfaces 95 can include additional interfaces. The incident interface 101 receives an incident record (i.e., information regarding an incident at the datacenter 15) from the root node 18, the service nodes, the physical nodes of the datacenter 15, or another system. The SLA interface 102 receives an SLA record (i.e., information regarding the SLA rules or parameters at each node level). The interfaces 101 and 102 can include, for example, a connector interface, a storage device interface, or a local or wireless communication port which receives the record from the datacenter 15. In one example, the incident records and the SLA records from the datacenter 15 can be used to create or supplement databases stored in the memory 94.

The processor 92 includes a control unit 103 and may be implemented using any suitable type of processing system where at least one processor executes computer-readable instructions stored in the memory 94. The memory 94 includes any suitable type, number, and configuration of volatile or non-transitory machine-readable storage media to store instructions and data. Examples of machine-readable storage media in the memory 94 include read-only memory (“ROM”), random access memory (“RAM”) (e.g., dynamic RAM rDRAM1, synchronous DRAM [“SDRAM”], etc.), electrically erasable programmable read-only memory (“EEPROM”), flash memory, hard disk, an SD card, and other suitable magnetic, optical, physical, or electronic memory devices. The memory 94 may also be used for storing temporary variables or other intermediate information during execution of instructions to be executed by processor 92.

The memory 94 may also store an operating system 105, such as Mac OS, MS Windows, Unix, or Linux; network applications 110; and various modules (e.g., an incident analysis module 96). The operating system 105 can be multi-user, multiprocessing, multitasking, multithreading, and real-time. The operating system 105 can also perform basic tasks such as recognizing input from input devices, such as a keyboard, a keypad, or a mouse; sending output to a projector and a camera; keeping track of files and directories on memory 94; controlling peripheral devices, such as disk drives, printers, image capture device; and managing traffic on the bus 100. The network applications 110 include various components for establishing and maintaining network connections, such as computer-readable instructions for implementing communication protocols including TCP/IP, HTTP, Ethernet, USB, and FireWire.

The machine-readable storage media are considered to be an article of manufacture or part of an article of manufacture. An article of manufacture refers to a manufactured component. Software stored on the machine-readable storage media and executed by the processor 92 includes, for example, firmware, applications, program data, filters, rules, program modules, and other executable instructions. The control unit 103 retrieves from the machine-readable storage media and execute, among other things, instructions related to the control processes and methods described herein.

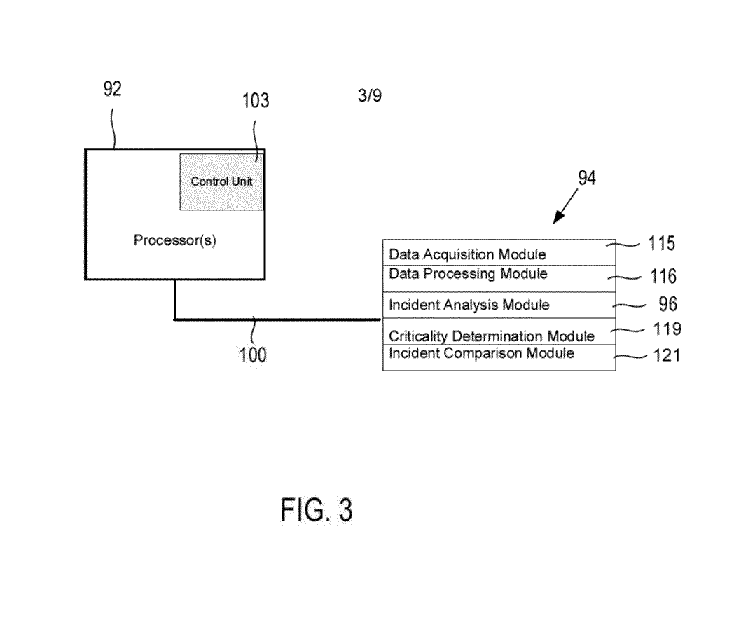

FIG. 3 illustrates an example of the machine-readable storage medium 94 encoded with instructions executable by the processor 92 of the system 10. In one example, the machine-readable storage medium 94 includes a data acquisition module (“DAQ”) 115, a data processing module 116, the incident analysis module 96, a criticality determination module 119, and an incident comparison module 121. In other examples, the machine-readable storage medium can include more or fewer modules.

As explained in additional detail below, the incident analysis module 96 provides various computer-readable instruction components for calculating an actual impact for an existing SLA for the datacenter 15 based on an incident related to a node of the datacenter 15, calculating a final actual impact and a total financial impact, and calculating a first probabilistic estimate of a penalty based on outage time at each service node. The criticality determination module 119 provides various computer-readable instruction components for determining a criticality of an incident at a service node of the datacenter 15 based on the time-to-violation and a probabilistic financial penalty estimate based on the incident. The incident comparison module 121 provides various computer-readable instruction components for comparing the criticality of at least two incidents in the datacenter 15.

Information and data associated with the system 10, the datacenter 15, the SLAs for the datacenter 15, and other systems/devices can be stored, logged, processed, and analyzed to implement the control methods and processes described herein. In addition to the data acquisition module 115, the memory 94 includes a data logger or recorder 120 and a database 125. The DAQ module 115 receives information or data from the datacenter 15 and from various external devices or systems. In one example, the DAQ module 115 receives SLA rules or parameters for each node in the datacenter 15 and incident records related to incidents in the datacenter 15 (i.e., while the incidents are in progress).

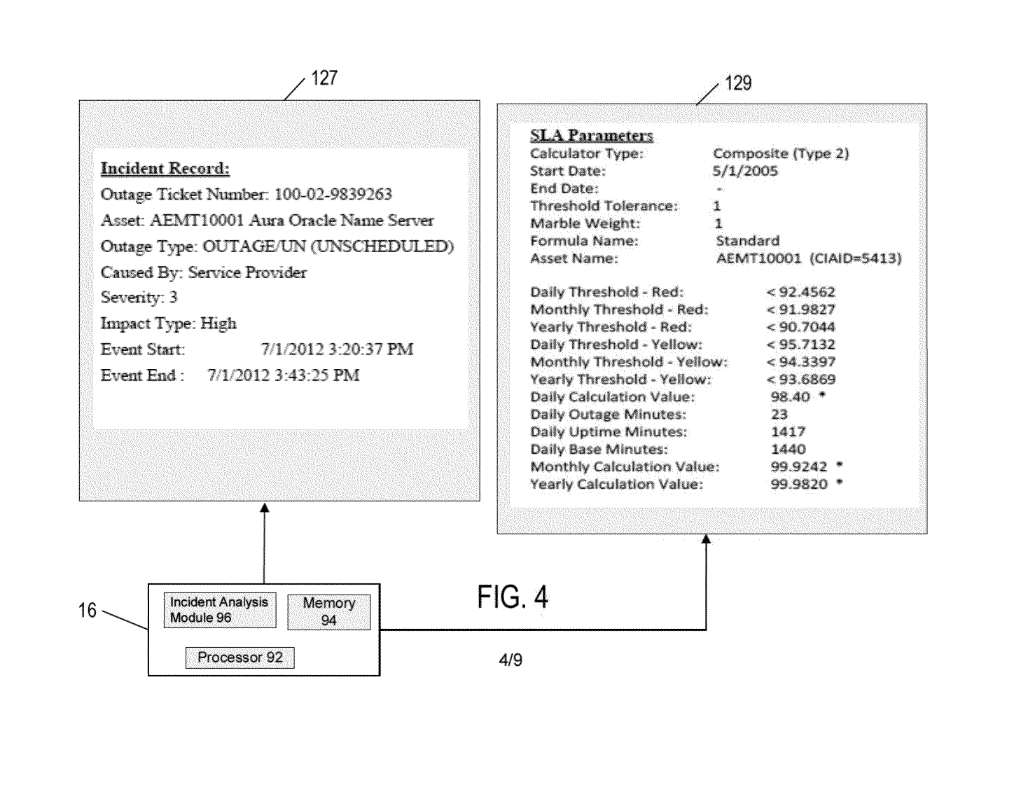

FIG. 4 illustrates an example of an incident record 127 for an incident related to a service at a service node of the datacenter 15 and an SLA parameters record 129 for a specific node that defines the level of services provided by the service provider at that node level. When an incident related to a specific service (e.g., the Database Service 65) occurs at a service node (e.g., node 65), an incident record 127 is created for the incident either by service-desk personnel or automatically generated by monitoring systems in the datacenter 15. As illustrated in FIG. 4, the incident record 127 includes various parameters (e.g., ticket number, asset or service node identifier (e.g. server name, service name), outage type, caused by, severity, impact type, start time, end time, etc.). The incident record may include more or fewer parameters. The DAQ module 115 receives the incident record 127 from the datacenter 15.

The DAQ module 115 also receives SLA parameters records 129 for the nodes at the datacenter 15. As noted above, SLA rules are defined at each service (i.e., each service node or node level 18, 20, 25, etc.) to govern or describe the services provided by the service provider. For example, the rules defining the main SLA for the datacenter 15 are defined at the root node 18. Further, independent local SLA rules may be defined for any of the service nodes below the root node 18 (e.g., nodes 20, 45, etc.) and for nodes that represent the physical entities (e.g., nodes 60, 70, 75, etc.) that support the service nodes.

Each SLA parameters record 129 includes different information or parameters about the SLA rules at the specific node. The illustrated SLA parameters record 129 is only an example, and other SLA parameters records 129 can include more or fewer parameters (e.g., service availability for each service, planned downtime, unplanned downtime, required uptime period, standby time, number of physical entities required to support a service, etc.). In one example, after the SLA rules are defined at each node, the DAQ module 115 receives the SLA parameters records 129 for all SLAs in the hierarchical datacenter structure 15. In another example, the SLA parameters records 129 for the nodes in the datacenter 15 are stored at each node and the computing device 16 receives information regarding the SLA parameters records 129 from each node when an incident at the node occurs. Based on the incident record 127 and the SLA parameters record 129 for the specific node, the computing device 16 executes instructions related to the control processes and methods described herein.

Some of the specific SLA parameters included in the SLA parameters record 129 and the incident record 127 have a significant influence on calculating the actual impact and the financial impact that an incident has on the SLA. For example, the “severity” parameter in the incident record 127 refers to the degree of impact caused by an incident. In some situations, the severity levels of an incident are predefined in the SLA and are included in the SLA parameters record 129 when one is generated. For example, severity levels between 1 and 5 can be used to classify incidents, where 1 can be the most severe (impactful) level and 5 the least severe level. Further, the SLA rules may specify that only incidents with a severity level less than 3 will cause an outage to the customer's service. Therefore, if the incident record 127 indicates that the severity level for a particular incident is 3, the control unit can determine that the incident will not cause an outage and will not have an actual or a financial impact to the SLA.

In addition, the “caused by” parameter in the incident record 127 indicates the party who caused the incident (i.e., who is at fault). For example, in many instances where clients maintain their application but the infrastructure supporting the application is outsourced to the service provider, a fault in the application (e.g. a software bug) is considered as the incident is “caused by” the client and the provider is not at fault. Therefore, in that case, an incident will not have an actual or a financial impact to the SLA. The “caused by” parameter is defined for each SLA node level at the datacenter 15 and is also used to filter out incidents caused by third-parties (e.g., software upgrade, vendor's software patch, etc.) or incidents where the root-cause of the outage was due to the customer's own activities.

Since SLA rules are specific at each node level, the clock time when the incident occurs is also important for evaluating the impact of the incident on the SLA. If the incident is during the planned or scheduled downtime of the service (e.g., weekdays 12:00 a.m.-5:00 a.m.), that incident will not impact the SLA. Alternately, if the incident is during an unplanned downtime which is not specifically described in the SLA, the provider may be liable financially (e.g., when the unplanned downtime exceeds an agreed limit for the specific time period).

The information gathered by the DAQ module 115 is provided to the data processing module 116 and the data logger or recorder 120. The data processing module 116 processes the information gathered by the DAQ module 115. The data logger or recorder 120 stores the information (e.g., incident records 127, SLA parameters record 129, etc.) in the database 125 for further storage and processing. In one example, the database 125 is included in the memory 94 of the computing device 16. In another example, the database 125 is a remote database (i.e., not located in the computer 60). In that example, the data logger or recorder 120 provides the information through a network (e.g., the network 17) to the database 125. Alternatively, the database 125 can be included in the components of the datacenter 15.

Therefore, the information and data stored in the database 125 can be accessed by the computing device 16 for processing and analysis. For example, the computing device 16 may process and analyze the received incident records 127 (while an incident is still in progress), along with the SLA parameters records 129 that may be stored in the database 125 to calculate an actual impact and a financial impact for an existing SLA for the datacenter 15. As noted above, the control unit 103 retrieves from the machine-readable storage media and executes, among other things, instructions related to the control processes and methods described herein. In some situations, more than one incident occurs at the datacenter 15. When executed, the instructions cause the control unit 103 to receive at least two incident records related to two incidents at the datacenter 15. For each incident record, the instructions cause the control unit 103 to calculate an actual impact of the incident at a first node, transfer the actual impact calculated at the first node to a parent node until a root node is reached, calculate an actual impact of the incident at the parent node, calculate a final actual impact and a total financial impact for the main SLA at the root node, calculate a time-to-violation of the main SLA at the root node, and determine a criticality of each incident based on the time-to-violation and the total financial impact. Further, the instructions cause the control unit 103 to compare the criticality of the at least two incidents.

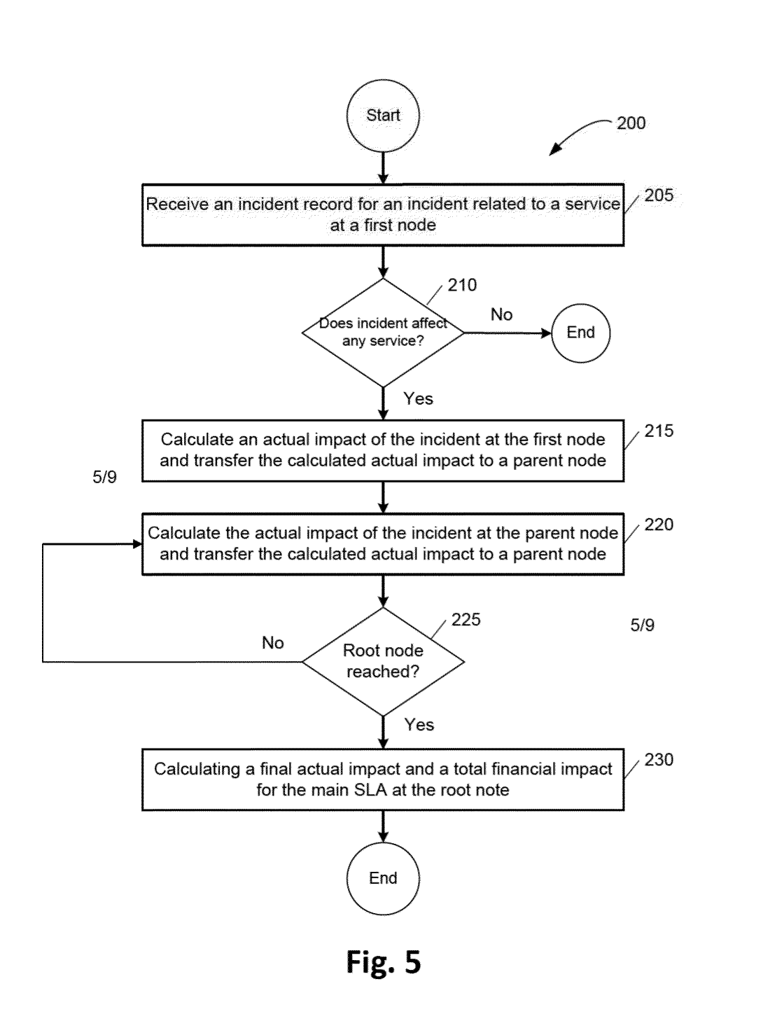

FIG. 5 illustrates a flow chart showing an example of a method 200 for calculating an actual impact and a financial impact for an existing SLA for the datacenter 15 based on an incident in the datacenter. The method 200 can be executed by the control unit 103 of the processor 92. Various steps described herein with respect to the method 200 are capable of being executed simultaneously, in parallel, or in an order that differs from the illustrated serial manner of execution. The method 200 is also capable of being executed using additional or fewer steps than are shown in the illustrated examples.

The method 200 may be executed in the form of instructions encoded on a non-transitory machine-readable storage medium (e.g., medium 94) executable by the processor 92. In one example, the instructions for the method 200 are stored in the incident analysis module 96.

The method 200 begins in step 205, where the control unit 103 receives an incident record 127 (e.g., via the DAQ module 115) for an incident related to a service at a first node. For example, when an incident occurs at the Database Service (i.e., node 65), an incident record 127 is generated and sent to the computing device 16. The incident may be related to a physical component of the Database Service (e.g., server, database, network, etc.). As noted above, the incident record 127 includes various parameters containing information related to the incident (e.g., the name of the asset and the service node, etc.). Next, at step 210, the control unit 103 determines if the incident affects any service in the hierarchical structure or datacenter 15. The asset filed or parameter of an incident record 127 includes the actual physical component which is experiencing the incident (e.g., a database server 66) and the service that is related to the physical component (e.g., Database Service 65). In one example, the control unit 103 compares the asset parameter in the incident record 127 with information regarding the nodes in the datacenter 15. If the asset parameter (i.e., information about the physical component) in the incident record 127 is not matched with any of the nodes of the datacenter tree 15, the control unit 103 determines that the incident does not affect any service in the datacenter 15. In that situation, that analysis of the incident in relation to the datacenter 15 stops. The incident can be tagged as non-impacting the datacenter 15 and datacenter personnel can assign a lower priority to that incident.

If the asset parameter in the incident record matches with a specific service node in the datacenter tree 15, the control unit 103 calculates an actual impact of the incident at the first node (i.e., the Database Service node 65) and transfers the calculated actual impact to a parent node (i.e., the Content Management Service node 40) until a root node (i.e., the E-Commerce Service node 18) is reached (at step 215). In one example, calculating the actual impact of the incident at each node (i.e., the first node where the incident is detected, its parent node, etc.) includes evaluating the incident record 127 and the local SLA rules (i.e., SLA parameters record 129) at each node at the node level (i.e., at the level of each node of the datacenter tree 15) with the incident analysis module 96. In particular, calculating the actual impact of the incident at each node includes determining an outage time (i.e., unplanned outage time or downtime) based on the incident record 127, the local SLA rules at each node defined by the SLA parameters record 129, and physical entities supporting each node. The actual impact at each node is calculated dynamically (i.e., by calculating values for each time metric unit (e.g., minute) of the incident) while the incident is in progress.

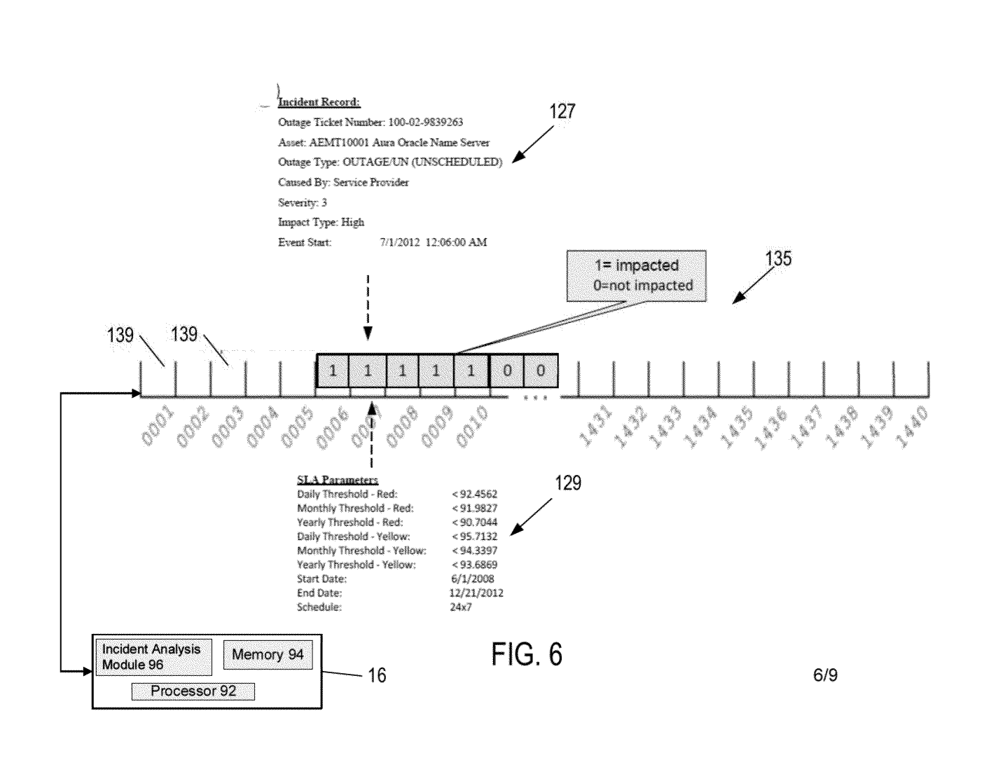

FIG. 6 illustrates an example of a time metric object 135 used for the calculation of the actual impact at each node. The time metric object 135 can also be used for dynamically calculating the final actual impact and the total financial impact at the root node. The time metric object 135 represents a specific time metric (e.g., a day) that is associated with each node in the datacenter tree 15 and includes a group of time metric units 139 (e.g., minutes). In the illustrated example, the time metric object 135 includes 1440 time metric units 139 (24 hours multiplied by 60 minutes per hour). After the control unit 103 receives the incident record 127, the control unit 103 calculates a value (i.e., outage time) for the actual impact at each node for each time metric unit 139 (i.e., each minute) of the incident.

Specifically, the actual impact or outage time is computed as follows. The control unit 103 analyzes the start time of the incident (i.e., the “event start” parameter in the incident record 127) and the current clock time using the time metric object 135. Each impacted time metric unit 139 is identified with “1” and each time metric unit 139 that is not impacted is identified with “0”. As illustrated in FIG. 6, if the incident starts at 12:06:00 a.m. and the current time is 12:10:00 a.m., the impacted time (i.e., the clock time recorded for the incident) is computed by subtracting the incident start time from the current clock time (i.e. the impacted time is five minutes). With every passing minute of the incident, the impact time increases, so the control unit 103 dynamically computes the outage time for every accumulated time metric unit (i.e., minute) until the incident is closed.

Referring back to FIG. 5, the control unit 103 continues with the process in step 215 and evaluates the current impacted time (i.e., the clock time recorded for the incident), the local SLA rules at each node, and physical entities supporting each node to compute the outage time. As noted above, each service node may be covered by different SLA rules, where these rules may vary by the day of the week and the time of the day (e.g., regarding planned downtime). Specifically, the control unit 103 determines what is the planned downtime and unplanned downtime included in the SLA rules at the node (e.g., from the SLA parameters record 129). The control unit 103 also analyzes the physical entities supporting each node to determine what are the SLA rules related to these physical entities (e.g., if the SLA requires that two database servers 66 operate at the specific time of the incident and only one is running). Based on the analysis of the required service at the node and its resources, the control unit 103 calculates the outage time at each node (i.e., the actual impact of the incident at the node) for each time metric unit (e.g., minute) of the incident while the incident is in progress. That way, the control unit 103 can provide the outage time for an accident at run time (i.e., while the incident is in progress) so datacenter personnel can analyze the potential financial impact of the incident as the incident progresses.

In determining the actual impact of the incident at each node, the control unit 103 also considers a plurality of specific parameters. For example, the control unit 103 evaluates the “severity,” “caused by,” and “scheduled downtime” parameters” when determining the outage time. As noted above, the “severity” parameter refers to the degree of impact caused by an incident. If the SLA rules at the specific node define that only incidents with severity levels of one and two (when there are five severity levels) will cause outage time, no outage time is determined by the control unit 103 when the severity level of the incident is three and above. In addition, if the control unit 103 determines that the incident is “caused by” the customer or by a third party related to the customer, no outage time is determined for the actual impacted time of the incident.

Further, if the incident or a portion of the incident occurred during a scheduled or planned downtime, the control unit does not consider the planned downtime as part of the calculated outage time. For example, if the incident started at 12:06:00 a.m. and the current time is 12:12:00 a.m., the impacted time is seven minutes. However, if the SLA rules at that node include daily scheduled downtime between 11:45 p.m. and 12:10 a.m., the actual outage time will be only two minutes.

The calculated actual impact at the first node (i.e., the node where the incident occurred—e.g., the Database Service node 65) is then transferred or cascaded to a parent node (i.e., the Content Management Service node 40) of the first node until a root node (the E-Commerce Service node 18) is reached (at step 215). At step 220, the control unit 103 calculates the actual impact of the incident at the parent node. The actual impact is calculated by using the steps described above in relation to calculating an actual impact at the first node. Next, at step 225, the control unit 103 determines whether the root node of the datacenter tree 15 is reached. The control unit 103 continues to dynamically evaluate the incident in progress and will determine an actual impact at each parent node until the analysis reaches the root node 18.

Then, at step 230, the control unit calculates a final actual impact and a total financial impact for the main SLA at the root node 18. As noted above, the main SLA that governs the datacenter tree 15 is associated with the root node 18. The final actual impact and the total financial impact are calculated dynamically (i.e., by calculating values for each time metric unit (e.g., minute) of the incident) while the incident is in progress. The final actual impact is calculated by using the steps described above in relation to calculating an actual impact at each node. Calculation of the final actual impact computes a total outage time for the incident at the root node, which represents the unplanned outage time or downtime. As explained in additional detail below, calculating the total financial impact includes calculating a probabilistic estimate of a penalty based on the total outage time at the root node. At the root node, the control unit 103 calculates values for the final actual impact and the total financial impact for each time metric unit 139 (i.e., each minute) of the incident while the incident is in progress by using the metric object 135 and the time metric units 139. In particular, the value for the final actual impact includes the total outage time at the root node and the value for the total financial impact includes the probabilistic estimate of a penalty based on the total outage time at the root node.

In addition, at the root node, the control unit 103 calculates a remaining time before a violation of the main SLA occurs (also called “time-to-violation”). In one example, calculating the remaining time before a violation of the main SLA occurs includes deducting the total outage time (i.e., the unplanned downtime) determined based on the final actual impact at the time of evaluating the incident from total unplanned downtime available for a predetermined time period or time unit (e.g., one month). In other words, the “time-to-violation” indicates the number of minutes remaining until the end of a predetermined time period (i.e., month) before the previously defined SLA rules regarding the unplanned downtime are violated and the defined unplanned downtime is exceeded. Calculating the “time-to-violation” can be performed with the incident analysis module 96.

In normal datacenter operations, the “time-to-violation” is usually computed at the end of the day after the incident is dosed. The proposed system, method, and computer readable media provides this information to datacenter managers at run time (i.e., while the incident is in progress), so they can make a timely and informative decision regarding the incident.

In one example, the uptime period defined in the SLA is 99% of the total clock time for the month. Therefore, the unplanned downtime cannot be more than 1%. The total clock time for a month is calculated first (e.g., [30 days*24 hours/per day*60 minutes for hour]=43,200 minutes in a month of 30 days). Then, any planned downtime (i.e., the time the customer does not require any service) is subtracted from the total clock time for the month. If the planned downtime is 960 minutes (e.g., no service 12:00 a.m.-4 a.m. on Sundays), the actual base minutes for the uptime period are 43,200-960=42,240, which represents 100% uptime for the entire month. For the example above, 1% of unplanned downtime limit for 42,240 uptime minutes is approximately 422 minutes and “time-to-violation” is calculated based on this time. Thus, if the total outage time in the root node at the time of evaluating the incident is less than the unplanned downtime, there is no penalty violation of the SLA. The unplanned downtime changes during the predetermined time period (i.e., month). For example, if on the 15th of the month, the SLA at the root node has already accrued 100 minutes of unplanned downtime, the actual allowable unplanned downtime before an SLA violation occurs until the end of the month is 322.

Generally, when the Quality of Service falls below the defined level of services outlined in the SLA, the provider may incur financial penalties for each service disruption or incident on a time unit basis (e.g., generally a monthly basis although daily and yearly penalties can be applied). By using the incident analysis module 96, the control unit 103 determines the total financial impact at the root node (or at each service node where applicable) to translate the determined outage minutes of the actual impact to a potential financial penalty for each time metric unit (e.g., minute) of the incident while the incident is still in progress.

As noted above, an SLA allows for some cumulative outage time (i.e., unplanned downtime) during a given assessment period or time unit (e.g. 30, 100, 960, etc. minutes in a calendar month) with no penalty to the service provider. Under such SLA rules, the monthly cumulative total unplanned downtime is computed at the end of the month. If the total unplanned downtime exceeds the allowance for the time unit, a fixed financial penalty is applied. If the total unplanned downtime is below the allowance, there is no penalty. The financial penalty may range from few thousand dollars per service to few hundred thousand per incident. The financial penalties are determined for each SLA and are included in the SLA parameters record 129. In some examples, the financial penalty is determined on the main SLA and may be based on the total availability of the service at the root node or on a specific availability of the children nodes. Specifically, calculating the total financial impact the root node includes calculating a probabilistic estimate of a penalty based on the total outage time at the root node. In other examples, financial penalties, and consequently service financial impact, can be calculated at each service node of the datacenter 15 based on their specific SLA rules. Specifically, calculating the service financial impact at each lower level service node includes calculating a probabilistic estimate of a penalty based on outage time at each service node.

As noted above, if the total unplanned downtime is below the allowance, there may be no penalty to the service provider. Thus, in some examples, no penalty is actually incurred during an ongoing incident that leads to an outage and may never be incurred even at the end of the month as a result of the outage. However, every single incident that may not actually increase the total unplanned outage time to above the allowed unplanned outage, nevertheless makes it more likely that a penalty will in fact be applicable at the end of the month due to incidents that happen later in the month. Therefore the cost that an incident that causes an outage has to the service provider must to be computed probabilistically.

In one example, calculating the total financial impact at the service nodes (i.e., the root node and the lower level service nodes) by calculating a probabilistic estimate of a penalty is completed as follows. According to the proposed method, the outage time for the datacenter 15 is randomly distributed with a mean outage probability density of X per time metric unit (e.g., minute) of elapsed uptime. Further, a penalty $P for violating the SLA will apply if in an entire uptime period U there are more than R minutes of unplanned outage time, where R represents the unplanned downtime for the time period. In one example, the system evaluates the incident at a specific time T (e.g., based on the time metric units 139 in the time metric object 135) and the total outage time for the month up to that point T of analysis is represented by O. O is approximated by multiplying the mean outage probability density of Xto the time T (XT). Thus, the true penalty cost of each outage time metric unit 139 (i.e., minute) added to the total outage time O is $0 (i.e., zero dollars) until R, the unplanned downtime for the time period, is reached and $P when the total outage time O is greater than R.

However, the above computation cannot help the datacenter personnel because by the time the total outage time reaches R, the penalty is already incurred. Therefore, the proposed method calculates, before the end of the predetermined SLA allowance period (e.g., month), the probabilistic estimate of a penalty at the end of the predetermined SLA period. In other words, the method calculates the probability b that the remaining period of clock time for the month after time Twill incur a total outage time that is greater than R−O (i.e., greater than the remaining outage time after T until the unplanned downtime is reached). In one example, the probabilistic estimate of a penalty at the end of the predetermined time period is calculated as follows:

$C=$P*b (Eq. 1)

b=1−f(R−O,X*(U−T)) (Eq. 2)

where $C represents the probabilistic estimate of a penalty at the end of the predetermined time period at the time T under the SLA rules for the analyzed node, U represents the entire uptime period, R represents the unplanned downtime for the time period, X represents the mean outage probability density, O represents the total outage time for the month up to the time T, and f represents a Poisson cumulative probability function. In one example, the probabilistic estimate of a penalty at the end of the predetermined time period is visually presented to the datacenter personnel (e.g., via a report, table, etc.).

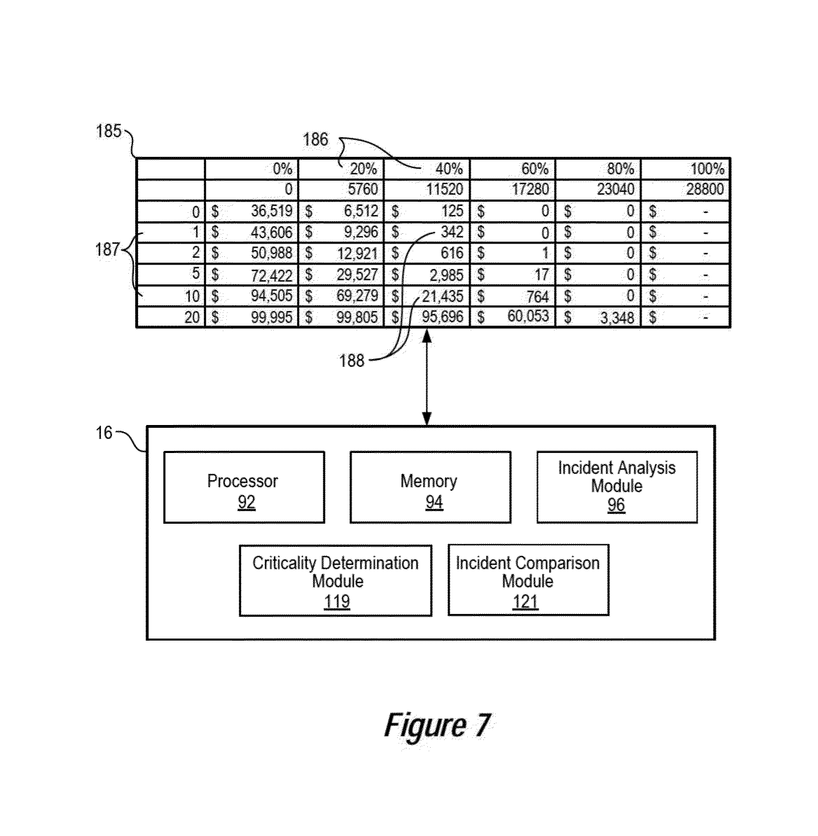

FIG. 7 shows a table 185 illustrating an example of calculating a probabilistic estimate of a penalty at a node based on an incident. In one example, the column headings 186 in the table 185 show the percentage of the scheduled uptime or the clock time (depending on whether the mean outage probability density X is defined using the scheduled uptime or the clock time) for the specified time frame (i.e., month) that has already passed. In the illustrated example, the scheduled uptime under the SLA is 28,800 minutes (e.g., twenty four hours coverage for twenty weekdays in a month). The row headings 187 in the table 185 show the number of minutes for which the penalty is being computed (i.e., the number of outage minutes determined based on the actual impact calculation at a specific time of the incident).

The cells 188 in the table 185 show the probabilistic expectation of penalty based on the current number of outage minutes. For the illustrated calculation, the mean outage probability density X per time metric unit (e.g., minute) is one minute per one thousand elapsed minutes of uptime (i.e., the assumption is that outages occur randomly at an expected rate of one minute for every one thousand uptime minutes). Further, the SLA rules define no penalty if the unplanned outage for the month is thirty minutes or less, and a penalty of $100,000 applies if the unplanned outage exceeds thirty minutes.

In one example, if the incident occurs at an uptime that is at 40% of the scheduled uptime for the SLA performance period, and only one minute of outage has accumulated up to that point, the probabilistic expectation of penalty at the end of the period will be $342. Thus, it is highly unlikely that this incident will trigger the $100,000 penalty. Any additional unplanned outage at this time will increase the expected penalty. The increase will be small (e.g., $342) if the following unplanned outage lasts for a minute or less. However, if the unplanned outage lasts ten minutes, the probabilistic expectation of penalty will rise to $21,435. Further, if the additional unplanned outage lasts twenty minutes, twenty one minutes of the allowed unplanned outage (which is thirty minutes) will be used for the first half of the performance period. In this case, it is highly likely that the service provider will eventually incur the penalty and the probabilistic expectation of penalty at that point is $95,696, very close to the $100,000 penalty.

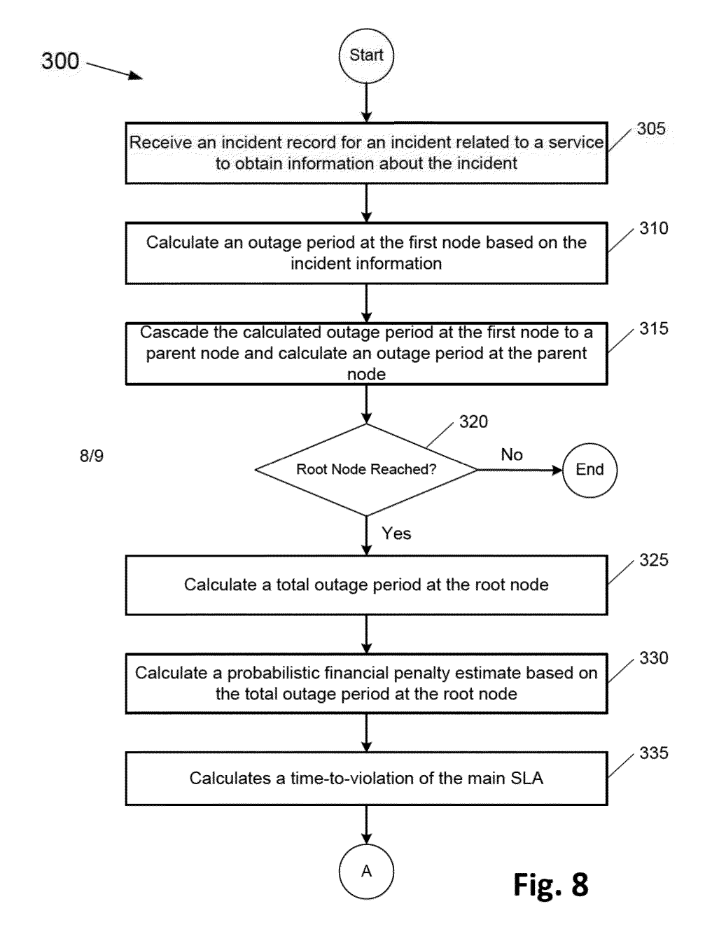

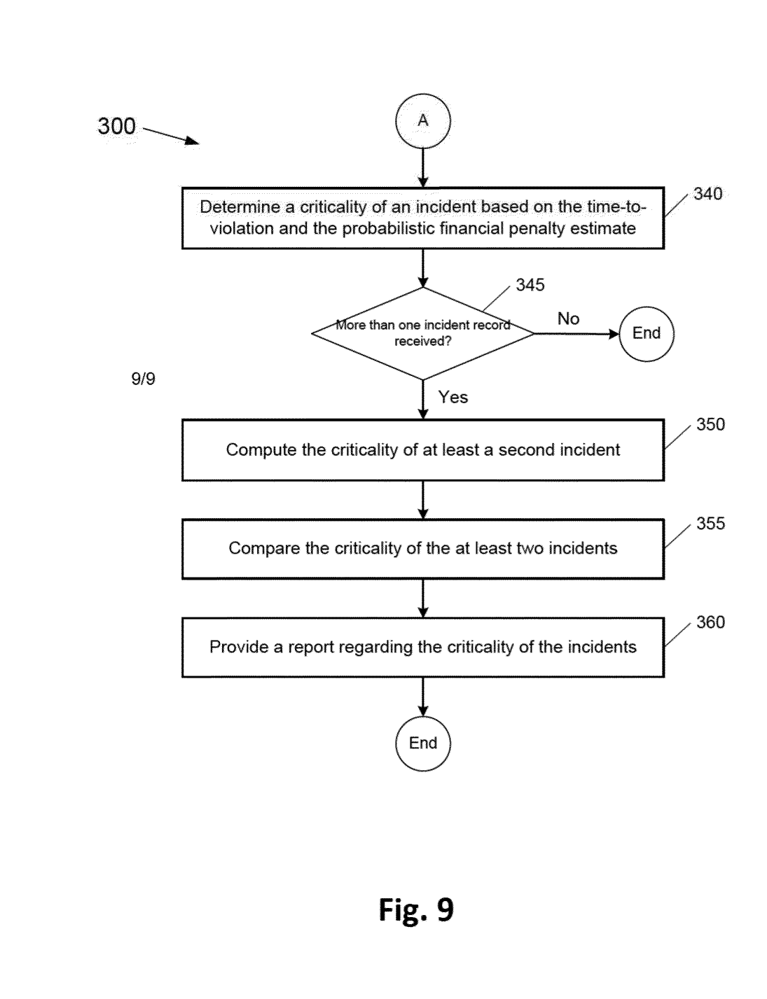

FIGS. 8 and 9 illustrate flow charts showing an example of a method 300 for determining a criticality of an incident at a node included in a hierarchical datacenter structure 15 and for comparing the criticality of at least two incidents at the structure 15. The method 300 can be executed by the control unit 103 of the processor 92 and instructions for the method 300 can be stored in the incident analysis module 96, the criticality determination module 119, and the incident comparison module 121. Various steps described herein with respect to the method 300 are capable of being executed simultaneously, in parallel, or in an order that differs from the illustrated serial manner of execution. The method 300 is also capable of being executed using additional or fewer steps than are shown in the illustrated example. The method 300 is performed at run time (i.e., the time during which the incident is progressing).

The method begins at step 305 where the computing device 16 obtains, at run time, information about an incident at a first node included in the hierarchical datacenter structure 15 that is related to a main SLA. In one example, the control unit 103 receives an incident record 127 related to the incidents. Next, at step 310, the control unit 103 calculates, at run-time, an outage period at the first node based on the incident information. In other words, the control unit 103 calculates the actual impact of the incident at the first node by analyzing the incident record, local SLA rules at each node, and physical entities supporting each node at the node level. This process was described in detail above.

In the next step, the control unit cascades the calculated outage period at the first node to an upper node and calculates an outage period at the parent node based on the incident information until a root node of the hierarchical structure is reached (at step 315). Next, the control unit determines if a root node is reached (at step 320), and calculates a total outage period at the root node (at step 325). In other words, the control unit calculates a final actual impact for the root node using the method steps described above.

Then, the control unit 103 calculates, at run time, a probabilistic financial penalty estimate based on the total outage period at the root node (at step 330). The calculation of the probabilistic financial penalty estimate (i.e., the total financial impact) is described in the preceding paragraphs. Next, at step 335, the control unit 103 calculates, at run-time, a time-to-violation of the main SLA. In one example, as explained in more details above, the control unit 103 subtracts the total outage period at the root node (at the specific time of the analysis) from the allowed unplanned downtime for a predetermined time period (i.e., a month) to determine the time-to-violation of the main SLA.

At step 340, the control unit 103 determines, at run-time, a criticality of an incident based on the time-to-violation of the main SLA and the probabilistic financial penalty estimate. The criticality is determined by the criticality determination module 119. In one example, the criticality of an incident is determined based on two main factors: 1) the probability b that the remaining period of clock time for the predetermined time period (e.g., month) after the current time T of analysis will incur a total outage time that is greater than the remaining outage time after T until the unplanned downtime is reached; and 2) the remaining time before a violation of the main SLA occurs (i.e., the number of minutes remaining until the end of the predetermined time period (i.e., month) before the SLA rules regarding the unplanned downtime are violated). The criticality of an incident can be presented to the datacenter personnel as a single metric unit or as a combination of the factors used to determine the criticality described above.

During a typical day of datacenter operations, multiple incidents occur within the same time period and datacenter managers have no effective way to compare the incidents based on their potential impact on the main SLA. The proposed method provides a basis for comparing multiple incidents in terms of cost per minute based on the outage created by the incidents. For that reason, at step 345, the control unit 103 determines if more than one incident record is received (i.e., if another incident is occurring at the same time as the first incident). If the control unit 103 determines that an incident is in fact occurring at the same time as the first incident, the control unit 103 computes the criticality for at least a second incident (at step 350) using steps 305-340 described above. In some examples, the control unit 103 can compute the criticality for a plurality of incidents that may occur at the same or different nodes of the datacenter 15.

Next, the control unit 103 compares the criticality of the at least two incidents (at step 355) with the incident comparison module 121. Alternatively, the control unit 103 can compare the criticality of a plurality of incidents. Comparing the criticality of the at least two incidents can include comparing a single metric unit (i.e., when the criticality is presented as such) or comparing the time-to-violation of the main SLA and the probabilistic financial penalty estimate for both incidents. In the final step, the control unit 103 provides a report regarding the criticality of the compared incidents. This report can include various metrics ranking the criticality of the incidents. For example, the report may include a single criticality score ranking the various incidents. Alternatively, the report can include information about the time-to-violation of the main SLA and the probabilistic financial penalty estimate for the incident. Because the method analyses the physical entities associated with the services, the method may also compute and the report may include an estimated time to fix the outage while the incidents are in progress. This metric allows for a more effective decision making regarding the incidents in a datacenter (e.g. repair, replace, build, and prioritize). The proposed quantitative approach enables incident management to compare multiple incidents in terms of potential financial impact as the outage occurs in real time.

What is claimed is:

1. A method for assessing the impact of an incident in a Service Level Agreement (SLA), the method performed by a system including a plurality of nodes organized in a hierarchical structure, the method comprising:
receiving an incident record for an incident related to a service at a first node;
calculating an actual impact of the incident at the first node;
transferring the calculated actual impact to a parent node until a root node is reached;
calculating the actual impact of the incident at the parent node; and
calculating a final actual impact and a total financial impact for the SLA at the root node,
wherein the actual impact at each node, the final actual impact, and the total financial impact are calculated dynamically while the incident is in progress.

2. The method of claim 1, wherein calculating the actual impact of the incident at each node comprises evaluating an incident record and local SLA rules for each node at a node level.

3. The method of claim 2, wherein calculating the actual impact of the incident at each node comprises determining an outage time based on the incident record, the local SLA rules at each node, and physical entities supporting each node.

4. The method of claim 1, further comprising calculating, at the root node, a remaining time before a violation of the SLA occurs.

5. The method of claim 4, wherein calculating the remaining time before a violation of the SLA occurs comprises deducting a total outage time, determined based on the final actual impact, from a planned downtime available for a predetermined time period.

6. The method of claim 5, wherein each node represents a service or a physical entity.

7. The method of claim 6, further comprising computing a service financial impact at each node that represents a service and includes a service SLA.

8. The method of claim 7, wherein calculating the service financial impact comprises calculating a first probabilistic estimate of a penalty based on outage time at each service node.

9. The method of claim 6, wherein calculating the total financial impact comprises calculating a second probabilistic estimate of a penalty based on the total outage time at the root node.

10. The method of claim 1, wherein dynamically calculating the actual impact at each node, the final actual impact, and the total financial impact comprises calculating values for the actual impact, the final actual impact, and the total financial impact for each time metric unit of the incident while the incident is in progress.

11. A system to assess the impact of an incident in a Service Level Agreement (SLA), the system comprising:
a computing device having a control unit to:
obtain, at run time, information about an incident at a first node included in a hierarchical structure that is related to the SLA
calculate, at run-time, an outage period at the first node based on the incident information;
cascade, at run time, the calculated outage period at the first node to a parent node until a root node of the hierarchical structure is reached;
calculate, at run time, an outage period at the parent node based on the incident information;
calculate, at run-time, a total outage period at the root node;
calculate, at run-time, a probabilistic penalty estimate based on the total outage period at the root node;
calculate, at run-time, a time-to-violation of the SLA;
determine, at run-time, a criticality of an incident based on the time-to-violation and the probabilistic penalty estimate.

12. The system of claim 11, wherein the run-time comprises the time during which the incident is progressing, and wherein the outage period for each node, the total outage period, and the criticality of an incident are determined for each time metric unit of the progressing incident.

13. The system of claim 11, wherein the control unit is to subtract the total outage period at the root node from a planned downtime available for a predetermined time period to determine the time-to-violation of the SLA.

14. The system of claim 11, wherein the control unit is to compare the incident information and local SLA rules at each node to compute the outage period at each node.

15. A non-transitory machine-readable storage medium encoded with instructions executable by a processor to assess the impact of an incident in a Service Level Agreement (SLA), the machine-readable storage medium comprising instructions to:
receive at least two incident records related to two incidents at a hierarchical structure that is related to the SLA and for each incident record:
calculate an actual impact of the incident at a first node;
transfer the actual impact calculated at the first node to a parent node until a root node is reached;
calculate an actual impact of the incident at the parent node;
calculate a final actual impact and a total financial impact for the SLA at the root node;
calculate a time-to-violation of the SLA at the root node; and
determine a criticality of each incident based on the time-to-violation and the total financial impact; and
compare the criticality of the at least two incidents.

16. The non-transitory machine-readable storage medium of claim 15, wherein the instructions to calculate the actual impact at each node comprises instructions to calculate an outage time by analyzing the incident record, local SLA rules at each node, and physical entities supporting each node at a node level.

17. The non-transitory machine-readable storage medium of claim 16, wherein the instructions to calculate the time-to-violation of the SLA comprises instructions to subtract a total outage time, determined based on the final actual impact, from a planned downtime available for a predetermined time period.

18. The non-transitory machine-readable storage medium of claim 16, wherein the instructions to calculate the total financial impact comprises instructions to calculate a probabilistic estimate of a penalty based a total outage time at the root node.

19. The non-transitory machine-readable storage medium of claim 15, wherein the instructions to calculate the actual impact, the final actual impact, and the total financial impact comprises instructions to calculate values for the actual impact, the final actual impact, and the total financial impact for each time metric unit of the incident while the incident is in progress.
